(19) United States
(12) Patent Application Publication
(10) Pub. No.: US 2009/0035561 A1
(43) Pub. Date: Feb. 5, 2009

(54) Protective oxide coatings for SOFC interconnections

(75) Inventors: Srikanth Gopalan, Westborough, MA (US); Uday B. Pal, Dover, MA (US); Soumendra N. Basu, Westwood, MA (US); Wenhua Huang, Malden, MA (US)

Correspondence Address: WEINGARTEN, SCHURGIN, GAGNEBIN & LEBOVICI LLP, TEN POST OFFICE SQUARE, BOSTON, MA, 02109, US

(73) Assignee: THE TRUSTEES OF BOSTON UNIVERSITY, Boston, MA (US)

(21) Appl. No.: 12/221,561

(22) Filed: Aug. 4, 2008

Related U.S. Application Data
(60) Provisional application No. 60/963,042, filed on Aug. 2, 2007.

(51) Int. Cl. B32B 5/00; B32B 15/04; C25D 13/00

(52) U.S. Cl. 428/336; 428/469; 204/471; 204/509

(57) ABSTRACT

A dense and well adhered spinel coating such as CuMn_{1.8}O₄, when deposited on a stainless steel substrate by electrophoretic deposition, significantly reduces the oxidation rate of the steel compared to the uncoated steel at elevated temperature. The protective oxide spinel coating is useful for preparing solid oxide fuel cell interconnects having long term stability at 800° C.

### CROSS-REFERENCE TO RELATED APPLICATIONS

This application claims priority to U.S. Provisional Application entitled PROTECTIVE OXIDE COATINGS FOR SOFC INTERCONNECTIONS filed on Aug. 2, 2007 and having Ser. No. 60/963,042, which is incorporated by reference herein.

### BACKGROUND OF THE INVENTION

Solid oxide fuel cells (SOFCs) have gained significant interest due to their high energy conversion efficiency, low pollution emission, and high fuel flexibility. Recent research on SOFCs is aimed at reducing the operating temperature to 650-850° C. This will enable the use of oxidation resistant alloys in place of the traditional ceramic interconnect materials used in high-temperature (˜1000° C.) SOFC stacks [1-9]. The metallic interconnects have many advantages including low materials cost, excellent mechanical properties, high thermal conductivity and easy manufacturing processing that is scalable to large areas. However, their lifetime is limited by the conductivity of the oxide scale, typically Cr₂O₃, (chromia), that forms on the surface. Chromia is electrically insulating, leading to higher contact resistance, which is deleterious to the fuel cell performance. In addition, volatile Cr species can be released from the Cr₂O₃ scale, depending on the temperature and partial pressures of H₂O and O₂ [10]. The presence of the volatile chromium species, notably CrO₂(OH)₂, in the cathode of an SOFC is known to cause rapid poisoning of the cathode and/or the cathode/electrolyte interface, and performance degradation [11].

The interconnection is a vital component in a fuel cell stack and connects the anode of a cell to the cathode of the adjacent cell. It is subjected to harsh environments at high temperatures in the range of 600-800° C., i.e., very oxidizing conditions on the cathodic side and very reducing conditions on the anodic side. Chromium and nickel based alloys are presently used as the interconnection materials, but they form poorly conducting oxidic scales under these conditions, especially on the cathodic side. Previously proposed protective coating layers include coatings of conductive perovskite compositions, such as Sr-doped lanthanum manganite, ferrite and chromite, which are often used as cathode and interconnect materials in SOFCs [6,13]. Protective spinel coatings also have been investigated. Previous work on spinel layers on stainless steel indicated that a (Mn,Co)₃O₄ spinel coating layer could be a promising barrier to chromium migration [14-16]. Copper-manganese spinels exhibit high electrical conductivity and a matching coefficient of thermal expansion at fuel cell operating temperatures [17,18].

Thus, a need exists for oxide film compositions that are electrically conductive and also suppress the rate of oxide layer growth.

### SUMMARY OF THE INVENTION

The invention provides an electrically conductive protective coating produced by electrophoretic deposition on a ferritic alloy, such as stainless steel. The coating comprises a spinel compound, such Cu₍ₓ₎Mn_{(y)}O_{(z)}, wherein x=1, 1.6≦y≦2.4, and z=4. In a preferred embodiment the protective coating contains CuMn_{1.8}O₄.

Another aspect of the invention is an electrical interconnect device for a solid oxide fuel cell. The interconnect device includes a stainless steel substrate and a protective oxide coating deposited on the substrate. The protective coating contains Cu₍ₓ₎Mn_{(y)}O_{(z)}, wherein x=1, 1.6≦y≦2.4, and z=4. In a preferred embodiment the protective coating contains CuMn_{1.8}O₄, and the stainless steel substrate is Crofer 22 APU.

Yet another aspect of the invention is a method of depositing an electrically conductive protective coating onto a ferritic alloy. The method includes providing a ferritic alloy substrate immersed in a liquid suspension of a spinel compound. In a preferred embodiment, the spinel compound has the formula Cu₍ₓ₎Mn_{(y)}O_{(z)}, wherein x=1, 1.6≦y≦2.4, and z=4. The spinel compound is electrophoretically deposited onto the substrate by applying a DC voltage between the substrate and an electrode immersed in the liquid suspension. The resulting coated substrate can be used as a solid oxide fuel cell interconnect.

### BRIEF DESCRIPTION OF THE DRAWINGS

Other features and advantages of the invention will be apparent from the following description of the preferred embodiments thereof and from the claims, taken in conjunction with the accompanying drawings, in which:

FIGS. 1A-1C are cross-sectional views of different embodiments of an SOFC interconnect with protective oxide coating according to the invention;

FIG. 2 is a schematic representation of a process for producing a protective oxide coating according to the invention;

FIG. 3 shows the results of an X-ray diffraction study of electrophoretically deposited CuMn_{1.8}O₄ coatings as deposited (trace (a)), after annealing at 800° C. for 100 h in air (trace (b)), after annealing at 800° C. for 200 h in air (trace (c)), and uncoated Crofer 22 APU stainless steel after isothermal oxidation at 800° C. for 200 h in air (trace (d));

FIGS. 4A and 4B show a scanning electron micrograph (SEM) of a spinel coating on Crofer 22 APU stainless steel at low (FIG. 4A) and high (FIG. 4B) magnification;

FIGS. 5A and 5B show the weight gain of uncoated (open circles) Crofer 22 APU and the same material coated with CuMn_{1.8}O₄ (filled circles) during isothermal oxidation at 800° C. (FIG. 4A) and 750° C. (FIG. 4B);

FIGS. 6A-6E show elemental distribution maps of unprotected Crofer 22APU after isothermal oxidation at 800° C. for 120 hours; FIG. 6A is an SEM for reference, and the remaining figures show the distribution of Fe (FIG. 6B), Cr (FIG. 6C), Mn (FIG. 6D), and O (FIG. 6E);

FIGS. 7A-7F show elemental distribution maps of CuMn_{1.8}O₄-protected Crofer 22APU after annealing at 800° C. for 100 hours; FIG. 7A is an SEM for reference, and the remaining figures show the distribution of Fe (FIG. 7B), Cr (FIG. 7C), Cu (FIG. 7D), Mn (FIG. 7E), and O (FIG. 7F);

FIGS. 8A-8F show elemental distribution maps of the CuMn_{1.8}O₄-protected Crofer 22APU of FIG. 7 after a further period of oxidation for 120 h at 800° C.; FIG. 8A is an SEM for reference, and the remaining figures show the distribution of Fe (FIG. 8B), Cr (FIG. 8C), Cu (FIG. 8D), Mn (FIG. 8E), and O (FIG. 8F);

FIGS. 9A and 9B show a schematic representation of the oxidation layer in an unprotected (FIG. 9A) and CuMn_{1.8}O₄-protected (FIG. 9B) Crofer 22APU after 120 h of oxidation; and

FIG. 10 shows the area specific resistance (APR) of Crofer 22 APU either untreated or CuMn_{1.8}O₄-protected after treatment at 800° C., as indicated.

### DETAILED DESCRIPTION

U.S. Provisional Application entitled PROTECTIVE OXIDE COATINGS FOR SOFC INTERCONNECTIONS, filed on Aug. 2, 2007 and having Ser. No. 60/963,042, is hereby incorporated by reference in its entirety.

The present invention provides a protective oxide coating applied on metallic alloys used as interconnect materials for solid oxide fuel cells. The coating is applied using an electrophoretic deposition technique and has been shown to significantly suppress the kinetics of oxide layer formation, thus extending the life of the interconnection material and the fuel cell stack. This invention also makes possible the use of less expensive stainless steels as solid oxide fuel cell interconnects, thereby reducing the overall stack cost. The protective oxide coating of the invention is also expected to suppress chromium diffusion into the cathode.

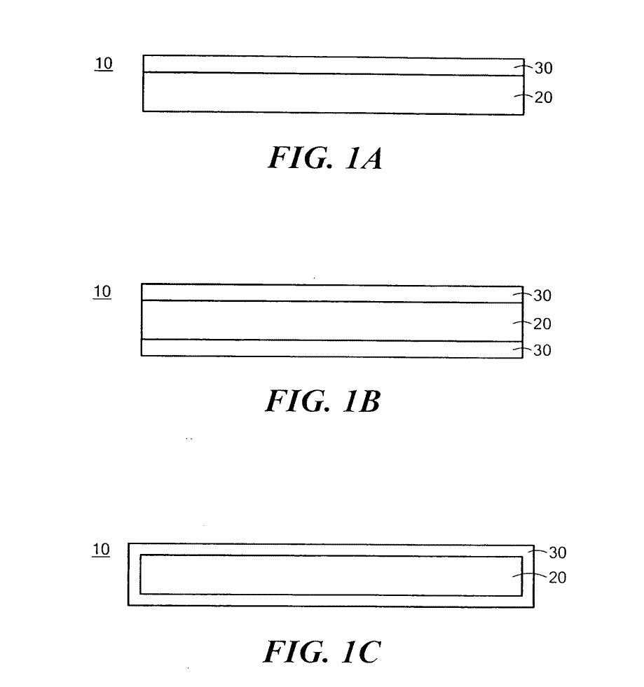

Referring to FIG. 1, SOFC interconnect 10 can be coated with a protective oxide coating in different configurations. FIG. 1A shows an embodiment in which substrate 20 comprising a ferritic alloy is coated on one side or face with protective oxide coating 30. For example, the substrate can be coated only on the side that in a fuel cell stack is in contact with a cathode surface, or on the side in contact with an anode surface, or the side in contact with an electrolyte-containing compartment. FIG. 1B shows an embodiment in which substrate 20 is coated on two faces with protective oxide coating 30. For example, in this embodiment the substrate can be coated on the side which in a fuel cell stack is in contact with a cathode surface as well as the side which is in contact with an anode surface, or the side which is in contact with an electrolyte-containing compartment, or any pairwise combination thereof. FIG. 1C shows a preferred embodiment in which substrate 20 is surrounded with protective oxide coating 30 deposited on all exposed surfaces of the substrate, i.e., the interconnect. Preferably, the coating is deposited so as to leave no gaps that might expose the substrate to air or that might limit conductivity of the interconnect surface.

A protective oxide coating according to the invention is a spinel coating that has been applied by electrophoretic deposition (EPD). A spinel is a mineral composition of the general formula AB₂O₄, where A and B can be divalent, trivalent, or quadrivalent cations, including magnesium, zinc, iron, manganese, copper, aluminum, chromium, titanium, and silicon. In a preferred embodiment, the spinel coating has a composition corresponding to Cu₍ₓ₎Mn_{(y)}O_{(z)}, where x=1, 1.6≦y≦2.4, and z=4. More preferably, the spinel coating has a composition corresponding to Cu₍ₓ₎Mn_{(y)}O_{(z)}, where x=1, 1.8≦y≦2.0, and z=4. In a preferred embodiment, the spinel coating has the formula CuMn_{1.8}O₄. Other variations in the composition family Cu₍ₓ₎Mn_{(y)}O_{(z)} may also be used, such as where x=1, z=4, and y=1.7, 1.9, 2.1, 2.2, or 2.3. Examples of other spinel compounds suitable for use in a protective oxide coating of the invention include MnCo₂O₄, Mn_{1.5}Co_{1.5}O₄, LaCrO₃, NiCrO₃, La_{0.8}Sr_{0.2}MnO₃, La_{0.8}Sr_{0.2}CrO₃, La_{0.8}Sr_{0.2}FeO₃, La_{0.67}Sr_{0.33}MnO₃, (La_{0.8}Sr_{0.15})_{0.9}MnO₃, La_{0.9}Sr_{0.1}CrO₃, La_{0.6}Sr_{0.4}CoO₃, La_{0.6}Sr_{0.4}CrO₃, and YₓCa₁₋ₓMnO₃ (where 0.1<x<0.4).

The coating can be deposited on the surface of an alloy being used as the interconnect using a range of deposition techniques. A preferred deposition technique is electrophoretic deposition (EDP). Other deposition techniques like thermal spraying, screen printing followed by sintering, air spraying followed by sintering, or sputtering also can be used to deposit a protective spinel layer, such as a spinel compound corresponding to Cu₍ₓ₎Mn_{(y)}O_{(z)}, where x=1, 1.6≦y≦2.4, and z=4.

A protective coating layer applied to an SOFC interconnect is intended to serve as a barrier to prevent chromium migration from the chromium-containing metal substrate, while minimizing the contribution of the interfacial contact to the area specific resistance between the cathode and the interconnect [12].

A ferritic alloy that serves as a substrate for deposition of a protective oxide coating according to the invention can be any ferritic alloy, such as a stainless steel. For use as an SOFC interconnect, the ferritic alloy is preferably resistant to oxidation, stable at high temperatures on the order of 800° C., and has a thermal expansion coefficient similar to that of other materials in the SOFC stack. Preferably, the ferritic alloy is a ferritic stainless steel such as a 400 series stainless steel, such as stainless steel types 430, 444, and 446. Especially preferred are Crofer 22 APU (UNS S44535), manufactured by ThyssenKrupp VDM GmbH (Germany), ZMG232, manufactured by Hitachi Metals Co., Ltd (Japan); and Ebrite (UNS 44627) manufactured by Allegheny Ludlum Corp. (USA); these are high temperature alloys especially designed for use as SOFC interconnects.

A substrate for use with a protective oxide coating or a method of the invention can have any shape or geometry required for its subsequent use after the protective coating is applied. For example, if the coated substrate is intended for use as an SOFC interconnect, it can have any form consistent with such application, including a flat plate, a plate with channels on one or both sides for electrolyte solution, fuel, or oxidant, or any form required by a given fuel cell stack geometry.

Any application requiring oxidation protection of ferritic alloys can in principle employ a protective coating according to the invention. In particular, a protective oxide layer according to the invention can be used in any application requiring corrosion resistance and simultaneously maintenance of an electrically conductive surface. For example, the coatings and methods of the invention can be used to prepare components of machinery or electronics that may be exposed to extreme conditions, such as high heat, and require an electrically conductive surface, resistance to oxidation, or resistance to migration of elements such as Cr out of the substrate.

A number of approaches can be used for applying protective layers on interconnect and coating materials. These include, e.g., plasma-spraying [19], electron-beam physical vapor deposition (EB-PVD) [20], and RF-magnetron sputtering [21]. However, these processes are generally expensive due to high capital equipment cost. In contrast, colloidal deposition routes are simple and inexpensive methods, and have been used, for example, to process advanced ceramics [22]. The electrophoretic deposition method (EPD) is a colloidal fabrication process in which charged particles dispersed in a liquid medium are attracted and deposited onto conductive and oppositely charged electrodes upon application of a DC electric field. EPC has the advantages of short deposition time, little restriction in the shape of substrates, simple deposition apparatus, and easy scalability for mass production. In particular, EPD offers easy control of the thickness and morphology of the deposited film through simple adjustment of the deposition time and applied potential [23]. For example, to increase film thickness, either the electric field strength can be increased, or the time of electrophoretic deposition can be increased, or both. Aqueous suspensions are used most often, but organic suspensions also can be used [24-25].

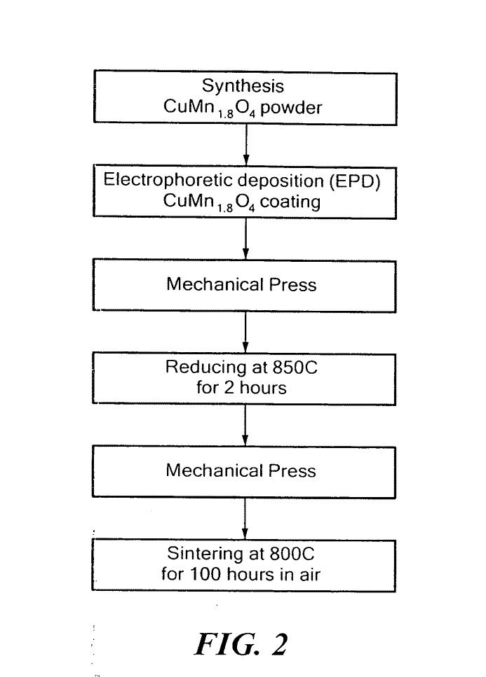

According to a method of the invention, a thin, dense, conductive spinel coating is deposited on a substrate containing or made entirely from a ferritic alloy, such as a ferritic stainless steel, using an EPD method. A flow chart for a coating procedure according to the invention is shown in FIG. 2. A spinel compound for the protective coating is prepared by dry mixing the appropriate ingredients in the required proportions followed by calcining and milling the composition to obtain a fine particulate material, e.g., having a particle diameter range of about 0.01 μm to about 1.0 μm, preferably an average particle diameter of about 0.1 μm. The powdered spinel composition is suspended in an appropriate liquid or solution for carrying out EPD. For example, the liquid can be a mixture of polar organic solvents, such as acetone/ethanol (3/1 by volume) with iodine (I₂) at 0.6 g/L. Preferred organic solvents are those that react with iodine to release protons, which adhere to the ceramic particles to give them a charge for electrophoretic deposition. An aqueous suspension can be used provided that the ceramic particles can be charged in the aqueous suspension. Optionally, the suspension can be mixed (e.g., ultrasonically) to assure homogeneity and disrupt any aggregated material, and then allowed to settle, so that remaining aggregates are removed. The spinel compound should be suspended at a concentration in the range from about 0.1 g/L to about 5 g/L, and preferably at a concentration of about 1.2 g/L. If the concentration is too low, EPD will be very slow, and if the concentration is too high, a significant amount of the spinel compound will form a sediment rather than remaining in suspension. The use of higher or lower concentration of spinel compound can be compensated for by reducing or increasing, respectively, either the voltage or time of EPD. Prior to carrying out EPD, the substrate optionally can be polished, e.g., using SiC paper up to 1200 grit.

The spinel coated can be deposited onto the substrate by establishing a constant voltage between the ferritic alloy substrate as the cathode and another electrode (the anode) placed in the spinel suspension, e.g., about 1.5 cm removed from the substrate. A voltage in the range from about 1 to about 200 V, preferably from about 1 to about 50 V, can be used; more preferably the voltage is about 20V. EPD is carried out for a time from about 0.1 min to about 100 min, preferably from about 5 to about 100 min, more preferably from about 5 to about 30 min, such as, for example, about 10 min. The voltage and time should be selected to provide the desired coating thickness, while maintaining a uniformly thick and dense coating, preferably avoiding conditions that might leave thin or bare zones that locally could reduce the corrosion resistance of the coating. Generally, a thickness in the range from about 1 μm to about 500 μm can be used.

Following the EPD step, the coating optionally is subjected to mechanical pressure followed by annealing at high temperature. Annealing should be performed at a temperature of at least 500° C. for a period of at least 1 hour. For example, the coating can be annealed at 850° C. for two hours. Following annealing, further optional steps include mechanical pressure and sintering at high temperature in air for an extended period of time (e.g., 800° C. for 100 h).

The following examples are presented to illustrate the advantages of the present invention and to assist one of ordinary skill in making and using the same. These examples are not intended in any way otherwise to limit the scope of the disclosure.

### EXAMPLES

### Example 1

A commercial ferritic stainless steel, Crofer 22 APU, with a chemical composition (in wt. %) of 22.8 Cr, 0.45 Mn, 0.08 Ti, 0.06 La, 0.005 C, ≦0.03 P, ≦0.03 S, balance Fe, was used as the substrate for the coating. Crofer 22 APU substrates of dimensions 25 mm×20 mm×0.5 mm were mechanically polished with various grades of SiC paper, up to 1200 grit. Prior to film deposition, the substrates were ultrasonically cleaned in acetone.

Powders of nominal composition CuMn_{1.8}O₄ were prepared by the solid-state reaction method. Proportional amounts of precursors CuO (99.99%) and Mn₂O₃ (99.9%) were thoroughly mixed and calcined at 1000° C. The calcined powders were crushed and ball-milled, after which the procedure was repeated. The average grain size of the powder used in this experiment was about 0.1 μm. The suspensions of CuMn_{1.804} spinel used in this study were prepared by mixing the spinel powder in acetone/ethanol (3/1 volume ratio) mixture with iodine. The concentration of CuMn_{1.8}O₄ in the suspension was maintained constant at 1.2 g/L. Before EPD of CuMn_{1.8}O₄ particles, the suspensions were dispersed ultrasonically for 20 min and then were allowed to settle for 10 minutes. Electrophoretic deposition experiments were carried out at a constant voltage 20 V for 10 min. After deposition, the coating was mechanically pressed and sintered at 800° C. for 100 h.

### Example 2

The coatings produced in Example 1 were characterized by X-ray diffraction (XRD) using a Bruker D8 Advance XRD system with Cu K_{α} radiation. The morphology of the coating was analyzed using scanning electron microscopy (SEM). The oxidation was continuously monitored by thermogravimetry using a TA Q600 thermobalance.

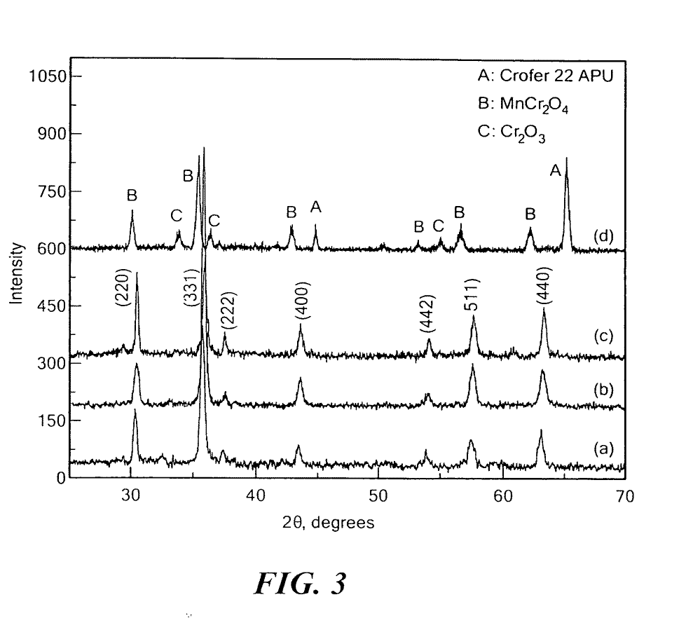

FIG. 3 shows the representative XRD spectra from the coating as-deposited by EPD, and the coating after sintering at 800° C. for 100 hours in air. The XRD results show that both the as-deposited coating and the coating sintered in air at 800° C. for 100 hours can be indexed to phase-pure CuMn_{1.8}O₄ spinel. From the location of the XRD peaks, the lattice parameter of the CuMn_{1.8}O₄ spinel phase was calculated to be 8.299 Å, which is slightly smaller than that of stoichiometric CuMn₂O₄ which has a lattice parameter of 8.305 Å. This is presumably due to the presence of additional manganese vacancies in the former phase.

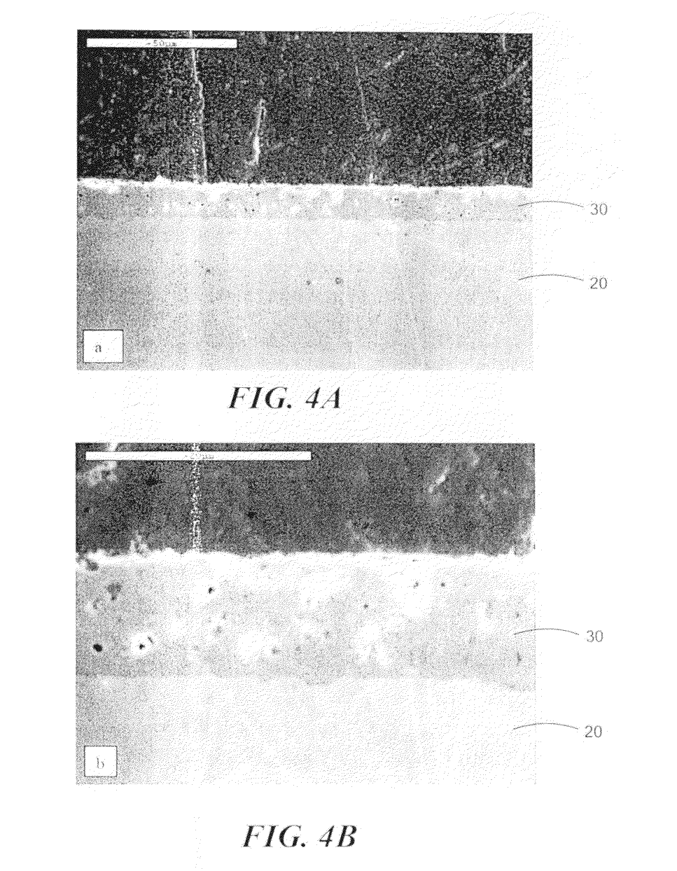

The cross-sectional view of CuMn_{1.8}O₄ spinel coating on Crofer 22 APU substrate sintered at 800° C. for 100 hours is shown in FIG. 4. The sample was embedded in epoxy, sectioned, and polished for visualization by scanning electron microscopy. The thickness of the spinel coating was about 15 μm and was uniform across the substrate. The sintered coatings were relatively dense, and there was neither delamination nor cracks at the interface, indicating that the adhesion of the coating on the substrate was very good.

### Example 3

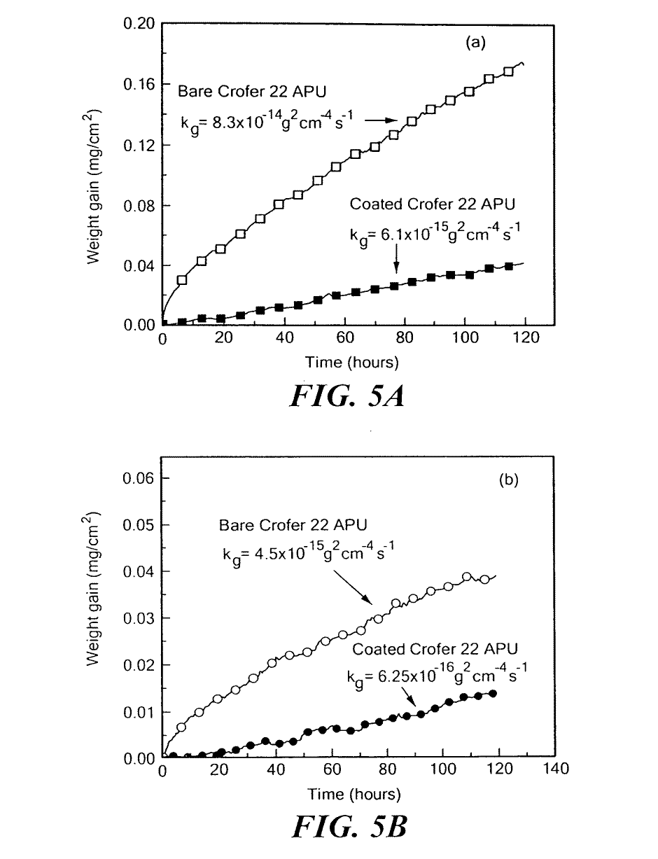

The results of an oxidation study for the CuMn_{1.8}O₄-coated Crofer 22 substrates of Example 1 are shown in FIG. 5. Oxidation kinetic measurements were carried out in air at 750° C. or 800° C. by thermogravimetry using a TA Q600 thermobalance. Weight gain for the coated steel was reduced very significantly compared to the uncoated steel. The weight gain of the uncoated and coated steel could be fitted to a near parabolic relationship with time. This is the expected relationship when the oxide scale growth is controlled by coupled diffusion of ions and electrons/holes through a dense scale. A rate constant, kg, characterizing the rate of weight gain, dΔW/dt, as a result of oxidation, can be defined by (ΔW)²=kg t. The observed rate constants are given in Table 1. Assuming the formed scale is Cr₂O₃, and using the density of bulk Cr₂O₃, the parabolic rate constant obtained by weight gain can be converted to a thickness change [26]. These rate constants (Table 1) show that at 750° C. and 800° C., the coated steel has a substantially reduced oxidation rate compared to the uncoated steel. The predicted oxide thickness of coated Crofer 22 APU after 50,000 hours at 800° C. is 6.4 μm, which corresponds to a one-fourth reduction in the oxide thickness formed on uncoated Crofer 22 APU. In addition, the dense nature of the coating is expected to substantially reduce the volatilization of the Cr₂O₃ scale, making this coating system an excellent candidate for oxidation-resistant layers on metallic interconnects in high-temperature SOFCs.

TABLE 1
Oxidation rate parameters for uncoated and coated Crofer 22 APU

| | Oxidation | | | Oxide thickness after |
|---|---|---|---|---|
| | temperature | k_{g} | kₚ | 50000 h (5.7 years) |
| | (° C.) | (g² cm⁻⁴ s⁻¹) | (μm h^{-1/2}) | (μm) |
| Uncoated Crofer | 800 | 8.3 × 10⁻¹⁴ | 10.51 × 10⁻² | 23.5 |
| 22 APU | | | | |
| | 750 | 4.5 × 10−¹⁵ | 2.45 × 10⁻² | 5.5 |
| Cu-Mn-O spinel | 800 | 6.1 × 10⁻¹⁵ | 2.87 × 10⁻² | 6.4 |
| coated Crofer 22 | | | | |
| APU | | | | |
| | 750 | 6.25 × 10⁻¹⁶ | 1.06 × 10⁻² | 2.4 |

### Example 4

Elemental distribution analysis was performed by SEM/EDX (SEM energy dispersive X-ray analysis). FIG. 6 shows elemental distribution maps of unprotected Crofer 22APU after isothermal oxidation at 800° C. for 120 hours. FIG. 6A is an SEM for comparison purposes, and the remaining parts of FIG. 6 show the distribution of Fe (FIG. 6B), Cr (FIG. 6C), Mn (FIG. 6D), and O (FIG. 6E). The Crofer 22 APU revealed a Mn-rich spinel oxide layer at the surface and a Cr-rich oxide layer below the Mn-rich spinel oxide layer, consistent with the XRD result shown in FIG. 3.

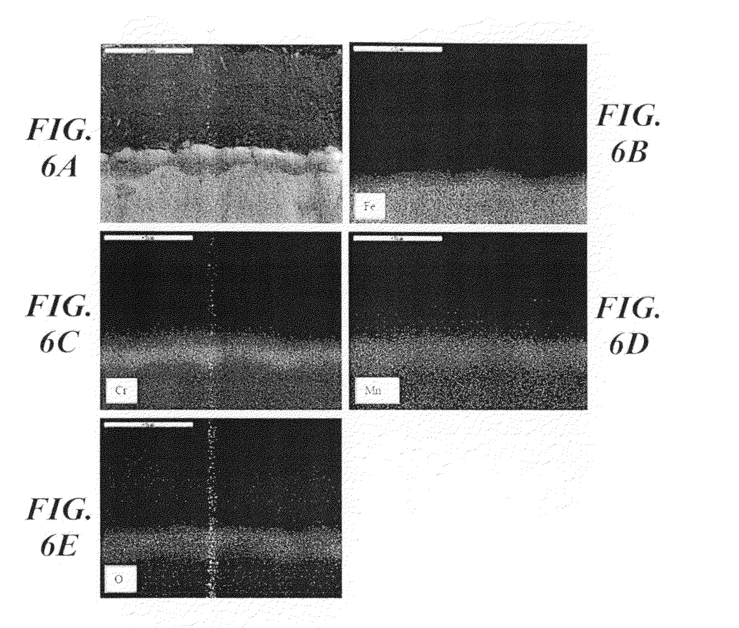

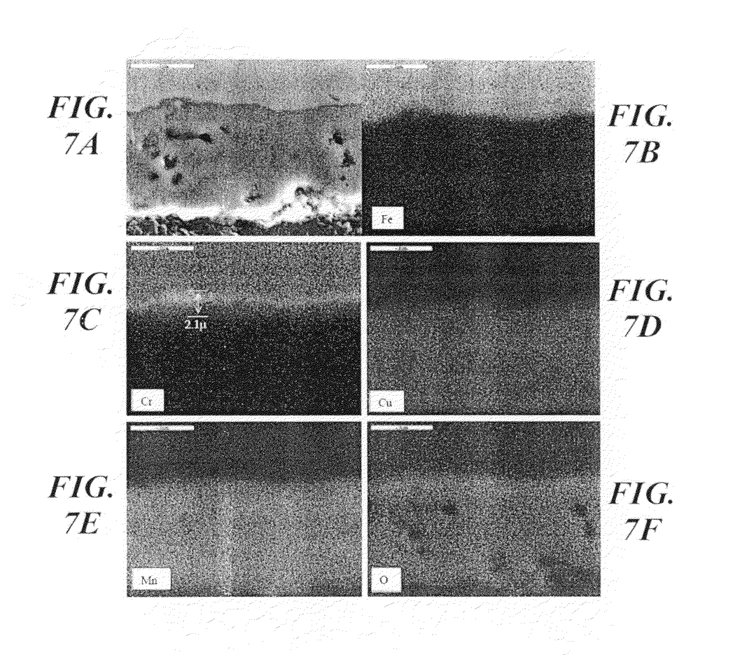

FIG. 7 shows elemental distribution maps of CuMn_{1.8}O₄-protected Crofer 22APU after annealing at 800° C. for 100 hours. FIG. 7A is an SEM for comparison, and the remaining parts of FIG. 7 show the distribution of Fe (FIG. 7B), Cr (FIG. 7C), Cu (FIG. 7D), Mn (FIG. 7E), and O (FIG. 7F). A thin layer of Cr₂O₃ and MnCr₂O₄ was formed between the steel and the CuMn_{1.8}O₄ coating during the annealing process. The thickness of this mixed oxide layer was about 2.1 μm. Note that the previously presented XRD results did not show these layers due to shielding by the coating layer of CuMn_{1.8}O₄.

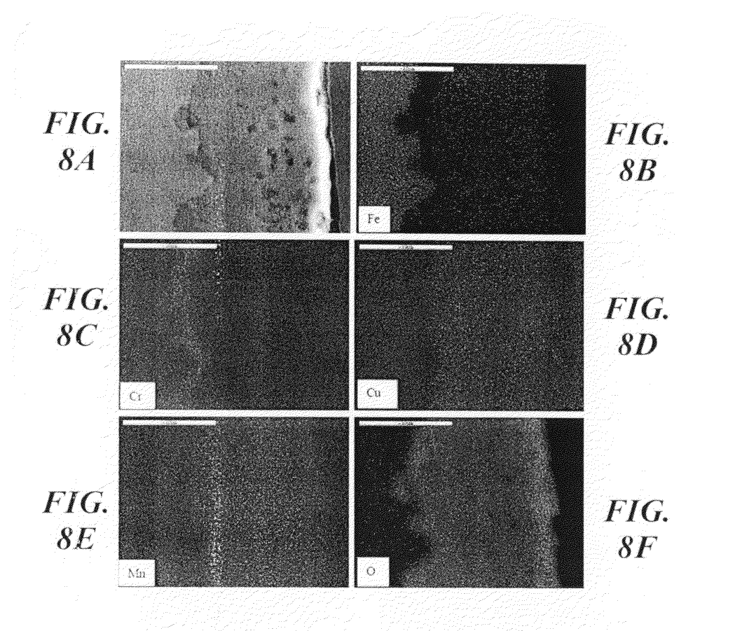

FIG. 8 shows elemental distribution maps of the CuMn_{1.8}O₄-protected Crofer 22APU of FIG. 7 after a further period of oxidation for 120 h at 800° C. FIG. 8A is an SEM for comparison, and the remaining parts of FIG. 8 show the distribution of Fe (FIG. 8B), Cr (FIG. 8C), Cu (FIG. 8D), Mn (FIG. 8E), and O (FIG. 8F). The mixed oxide layer of layer of Cr₂O₃ and MnCr₂O₄ was still present and has increased slightly in thickness compared to the results shown in FIG. 7. Note that there was no Cr present in the CuMn_{1.8}O₄ protective layer, indicating that the protective layer forms an effective barrier to Cr diffusion out of the alloy. There also was no diffusion of Cu into the Cr₂O₃ layer or any outward diffusion of Fe.

### Example 5

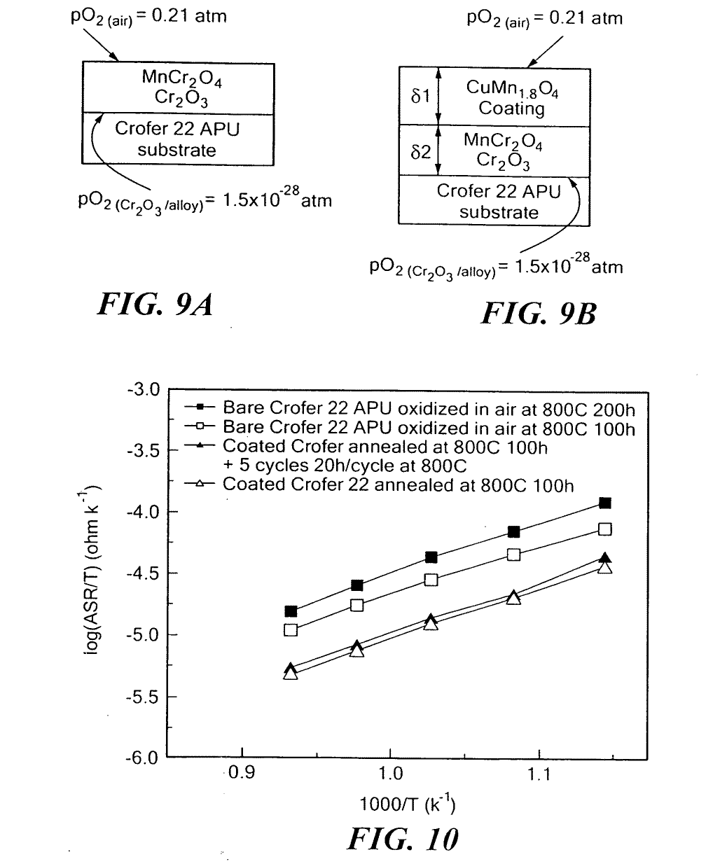

The effect of a protective coating according to the invention on the thermal oxidation of a ferritic steel substrate was estimated. Based on the data previously discussed, the structures of coated and uncoated Crofer 22 APU after thermal oxidation can be schematically displayed as in FIG. 9. For uncoated Crofer 22 APU after thermal oxidation (FIG. 9A), an oxide scale will form in which MnCr₂O₄ is at the outer surface of the oxide scale and Cr₂O₃ is between the MnCr₂O₄ and substrate. For coated Crofer 22 APU, the structure of the sample is shown in FIG. 9B. A spinel coating (e.g., CuMn_{1.8}O₄) is at the outer surface of the coated substrate, and the thermally grown oxide scale is between the coating and the substrate. The rate of the oxide growth can be represented by

$$\frac{d x}{d t} ,$$

where x is the oxide thickness, and t is time. The buildup of the oxide scale over time is due to the oxygen concentration difference between the oxide/alloy interface and the oxide/air surface. Thus, it is reasonable to assume that

$$\frac{d x}{d t} = K \frac{d {c}_{{o}_{2}}}{d x} ,$$

where K is a constant representing the effective diffusion coefficient. According to Wagner's theory of oxidation,

$$\frac{d x}{d t} = \frac{{k}_{p}}{x} ,$$

where kₚ is the parabolic rate constant. Then

$$\frac{{k}_{p}}{x} = K \frac{d {c}_{{o}_{2}}}{d x} = \frac{K}{RT} \frac{d ( p {O}_{2} )}{d x} \qquad ( 1 )$$

Integration of equation (1) through the thickness of the oxide layer yields

$$K = \frac{RT}{Δ p {O}_{2}} \times {k}_{p} = \frac{RT}{p {O}_{2} ( air ) - p {O}_{2} ( {CR}_{2} {O}_{3} / alloy )} \times {k}_{p} \qquad ( 2 )$$

where R is the gas constant, T is temperature, pO₂(air) is 0.21 atm and pO₂(Cr₂O₃/alloy) is 1.5×10⁻²⁸ atm, which is close to the known thermodynamic equilibrium oxygen partial pressure for the coexistence of Cr+Cr₂O₃. According to previous data, kₚ of uncoated and coated Crofer 22 APU at 800° C. are around 10.51×10⁻² and 2.87×10⁻² μm h^{-1/2}. Thus, the K value for uncoated and coated Crofer 22 APU can be estimated as 4.46×10³ and 1.22×10³, respectively. The K value for uncoated Crofer 22 APU is essentially the effective diffusion coefficient of MnCr₂O₄ and Cr₂O₃ mixed layer. And the K for coated Crofer 22 APU is essentially the combined effective diffusion coefficient of the spinel coating layer and the MnCr₂O₄ and Cr₂O₃ mixed oxide scale.

For a two-layer system, the K value of each layer can be treated as serial resistances. Thus, they will have the following relationship.

$$\frac{{δ}_{1} + {δ}_{2}}{{K}_{combined}} = \frac{{δ}_{1}}{{K}_{coating}} + \frac{{δ}_{2}}{{K}_{oxides}} \qquad ( 3 )$$

Here, δ₁ and δ₂ are the thicknesses of the coating and oxides, respectively. δ₁+δ₂ is the total thickness of the coating and the oxides. K_{coating} and K_{oxides} are the effective diffusion coefficient of the coating and oxides, respectively. K_{combined} is the combined effective diffusion coefficient of the coating and the oxides. As shown in FIG. 8B, the thickness of the coating layer is about 15 μm, and that of the MnCr₂O₄+Cr₂O₃ oxide layer is about 2 μm, according to previous data. The effective diffusion coefficient of the coating layer (K_{coating}) can be estimated at around 1.1×10³, which is only ¼ of the K_{oxides}. This means that the spinel coating is significantly more effective than the oxide scale at preventing the oxidation of the alloy in the substrate.

### Example 6

The area specific resistance of uncoated and CuMn_{1.8}O₄-coated Crofer 22 APU substrates was investigated. Area specific resistance (ASR) was measured according to Huang [27]. The resistivity of the substrate was assumed to be negligible compared with that of the thermally grown scale or electrophoretically deposited coating on the surface of the alloy substrate. Thus, the measured ASR includes that of the scale or scale+coating layer and its interface with the substrate and the Pt electrode. Since the current used (0.1 A) was relatively small, interfacial polarization was negligible. The measured ASR was therefore assumed to be that of the scale or scale+coating layer.

FIG. 10 shows plots of the log of ASR/T vs. 1000/T for the uncoated and CuMn_{1.8}O₄-coated Crofer 22 APU substrates after the indicated oxidation or annealing/oxidation conditions. The ASR decreased with increasing temperature, and a linear relation was found between log (ASR/T) and 1000/T for all samples, indicating that the oxide scale or scale+coating dominated the conduction for each of the samples. The activation energies of the samples (obtained from ASR/T=A exp(E₀/kT) were between 0.78 and 0.84 eV, close to the activation energy of 0.9 eV reported for Cr₂O₃ by Huang et al. [27].

The results shown in FIG. 10 indicate that the oxide scale formed on the uncoated steel after 200 h at 800° C. has a relatively high resistance. After the application of a CuMn_{1.8}O₄ spinel coating by electrophoretic deposition, however, the electrical resistance after the same thermal treatment was much lower than that of the bare substrate. This demonstrated that the spinel coating was effective in protecting the substrate from oxidation and in reducing the resistance of the interconnect material.

Using calculations according to Example 5, and assuming a parabolic increase over time of a Cr₂O₃ oxide layer under a CuMn_{1.8}O₄ spinel coating on a Crofer 22 APU substrate, the oxide thickness formed after 50,000 hours at 800° C. is estimated to be 6.4 μm. Given an electrical resistivity for Cr₂O₃ at 800° C. of about 18 Ω·cm [28], the ASR of a CuMn_{1.8}O₄ spinel coating on a Crofer 22 APU substrate is expected to provide an acceptable value of less than 0.1 Ω·cm² for SOFC interconnect materials over their expected service lifetime.

While the present invention has been described in conjunction with one or more preferred embodiments, one of ordinary skill, after reading the foregoing specification, will be able to effect various changes, substitutions of equivalents, and other alterations to the compositions and methods set forth herein. It is therefore intended that the protection granted by Letters Patent hereon be limited only by the definitions contained in the appended claims and equivalents thereof.

### REFERENCES

1. B. C. H. Steele and A. Heinzel, Nature 414, 345 (2001).
2. M. Dokiya, Solid State Ionics 383, 152 (2002).
3. S. de Souza, S. J. Visco and L. C. De Jonghe, Solid State Ionics 98, 57 (1997).
4. H. Ishihara, H. Matsuda and Y. Takita, J. Am. Chem. Soc. 116, 3801 (1994).
5. K. Q. Huang, R. Tichy and J. B. Goodenough, J. Am. Ceram. Soc. 81, 2565 (1998).
6. T. Kadowaki, T. Shiomitsu, E. Matsuda, H. Nakagawa, H. Tsuneizumi, and T. Maruyama, Solid State Ionics 67, 65 (1993).
7. K. Huang, P. Y. Hou and J. B. Goodenough, Materials Research Bulletin 36, 81 (2001).
8. Z. G. Yang, K. S. Weil, D. M. Paxton, and J. W. Stevenson, J. Electrochem. Soc. 150, A1188 (2003).
9. P. Kofstad and R. Bredesen, Solid State Ionics 52, 69 (1992).
10. H. Asteman, J.-E. Svensson, L.-G Johansson, M. Norell, Oxid. Met. 52 (1999) 95.
11. S. P. Jiang, J. P. Zhang, X. G. Zheng, J. Eur. Ceram. Soc. 22 (2002) 361.
12. Z. G. Yang, G. Xia, S. P. Simner, J. W. Stevenson, J. Electrochem. Soc. 152 (9), A1896 (2005).
13. W. J. Quaddakers, H. Greiner, M. Hansel, A. Pattanaik, A. S. Khanna, and W. Mallener, Solid State Ionics, 91, 55 (1996).
14. Y. Larring and T. Norby, J. Electrochem. Soc. 147 (9) (2000) 3251.
15. Z. G. Yang, G. Xia and J. W. Stevenson, Electrochem. Solid State Lett. 8 (3), A168 (2005).
16. X. Chen, P. Y. Hou, C. P. Jacobsona, S. J. Visco and L. C. De Jonghe, Solid State Ionics 176 (2005) 425.
17. H. Ling and A. Petric, Proc. 9th International Symposium on Solid Oxide Fuel cells IX, Quebec city, Canada (2005) 1866.
18. M. R. Bateni, P. Wei, X. Deng, A. Petric, Surf. Coat. Technol. 201 (2007) 4677.
19. W. J. Quadakkers, H. Greiner, M. Hanesl, A. Pattanaik, A. S. Khanna and W. Malléner, Solid State Ionics 91 (1996) 55.
20. N. Oishi, T. Namikawa and Y Yamazaki, Surf. Coat. Technol. 132 (2000)58.
21. C. Johnson, R. Gemmen and N. Orlovskaya, Composites Part B 35 (2004) 167.
22. P. Sarkar and P. S. Nicholson, J. Am. Ceram. Soc., 79 (8) (1996) 1987.
23. Y Hirata, A. Nishimoto and Y Ishihara, J. Ceram. Soc. Jpn., 99 (1991) 108.
24. M. Nagain, K. Yamashita, T. Umegaki and Y. Takuma, J. Am. Ceram. Soc., 76(1) (1993) 253.
25. C. E. Baumgarther, V. J. DeCarlo, P. G Glugla and J. Grimaldi, J. Electrochem. Soc., 38 (1986) 119.
26. P. Y. Hou, K. Huang, W. Bakker, Proc. 6th International Symposium on Solid Oxide Fuel Cells VI, Honolulu, Hi., (1999) 737-748.
27. K. Huang, P. Y. Hou and J. B. Goodenough, Solid State Ionics, 129 (2000) 237.
28. W. Qu, J. Li, J. M. Hill, and D. G Ivey, J. Power Sources 153 (2006) 114.

That which is claimed is:

1. An electrically conductive protective coating produced by electrophoretic deposition on a ferritic alloy, the coating comprising Cu₍ₓ₎Mn_{(y)}O_{(z)}, wherein x=1, 1.6≦y≦2.4, and z=4.

2. The protective coating of claim 1, wherein 1.8≦y≦2.0.

3. The protective coating of claim 2, wherein y=1.8.

4. The protective coating of claim 1, wherein the ferritic alloy comprises chromium.

5. The protective coating of claim 1, wherein the coating inhibits the formation of electrically insulating oxides at the surface of the ferritic alloy.

6. The protective coating of claim 1, wherein the coating inhibits chromium migration to the surface of the ferritic alloy.

7. The protective coating of claim 1 that reduces area specific resistance of the ferritic alloy compared to the ferritic alloy without the protective coating.

8. The protective coating of claim 1, wherein the thickness of the coating is in the range from about 1 μm to about 500 μm.

9. The protective coating of claim 1 having a thickness of about 15 μm.

10. An electrical interconnect device for a solid oxide fuel cell, the interconnect device comprising a stainless steel substrate and a protective oxide coating deposited on said substrate, wherein the protective coating comprises Cu₍ₓ₎Mn_{(y)}O_{(z)}, wherein x=1, 1.6≦y≦2.4, and z=4.

11. The interconnect device of claim 10, wherein 1.8≦y≦2.0.

12. The interconnect device of claim 11, wherein y=1.8.

13. The interconnect device of claim 10, wherein the stainless steel substrate comprises a material selected from the group consisting of stainless steel 430, stainless steel 444, stainless steel 446, Crofer 22 APU (UNS S44535), ZMG232, and Ebrite (UNS 44627).

14. The interconnect device of claim 13, wherein the stainless steel substrate is Crofer 22 APU.

15. The interconnect device of claim 10, wherein the thickness of the protective oxide coating is in the range from about 1 μm to about 500 μm.

16. The interconnect device of claim 15, wherein the thickness of the protective oxide coating is about 15 μm.

17. A method of depositing an electrically conductive protective coating onto a ferritic alloy, the method comprising
providing a ferritic alloy substrate immersed in a liquid suspension of a spinel compound; and
electrophoretically depositing the spinel compound onto the substrate by applying a DC voltage between the substrate and an electrode immersed in the liquid suspension.

18. The method of claim 17, further comprising the step of annealing the protective coating by heating the coated substrate in air at a temperature of at least 500° C. for a period of at least 1 hour.

19. The method of claim 17, wherein the spinel compound has the formula Cu₍ₓ₎Mn_{(y)}O_{(z)}, wherein x=1, 1.6≦y≦2.4, and z=4.

20. The method of claim 19, wherein 1.8≦y≦2.0.

21. The method of claim 20, wherein y=1.8.

22. The method of claim 17, wherein the DC voltage is in the range from about 1 to about 50V.

23. The method of claim 22, wherein the DC voltage is about 20 V.

24. The method of claim 17, wherein the DC voltage is applied for about 5 min to about 100 min.

25. The method of claim 24, wherein the DC voltage is applied for about 10 min.

26. The method of claim 17, wherein the spinel compound is suspended in a liquid comprising an acetone/ethanol mixture at a 3/1 volume ratio and 0.6 g/L of iodine.

27. The method of claim 17, wherein the liquid suspension comprises 1.2 g/L of the spinel compound.

28. The method of claim 17, wherein the substrate is polished prior to the step of electrophoretically depositing the spinel compound.

29. The method of claim 17, wherein the substrate comprises a stainless steel selected from the group consisting of stainless steel 430, stainless steel 444, stainless steel 446, Crofer 22 APU (UNS S44535), ZMG232, and Ebrite (UNS 44627).

30. The method of claim 29, wherein the substrate is Crofer 22 APU.
